(19) United States
(12) Patent Application Publication
(10) Pub. No.: US 2026/0169263 A1
(43) Pub. Date: Jun. 18, 2026

(54) MOLD, LENS, LENS UNIT, INFORMATION TERMINAL, IMAGING APPARATUS, AND MOLDING METHOD

(71) Applicant: CANON KABUSHIKI KAISHA, Tokyo (JP)

(72) Inventors: TOMOKI HOSHINO, Tochigi (JP); RYOHEI KANAME, Tochigi (JP); JUNNOSUKE NAKAMURA, Tochigi (JP); SATOSHI INOUE, Tochigi (JP)

(21) Appl. No.: 19/409,076

(22) Filed: Dec. 4, 2025

(30) Foreign Application Priority Data
Dec. 12, 2024 (JP) 2024-217351
Oct. 24, 2025 (JP) 2025-179472

(51) Int. Cl. G02B 13/00; C03B 11/08; G02B 7/02

(52) U.S. Cl. CPC G02B 13/002; C03B 11/08; G02B 7/021

(57) ABSTRACT

A lens is provided that includes a first optically effective surface and a second optically effective surface which intersect an optical axis, wherein: at least one of the first and the second optically effective surfaces has an inflection point between an intersection with the optical axis and an effective region end; a distribution of thickness between the first and the second optically effective surfaces in a direction parallel to the optical axis has an extreme value at a position away from the optical axis in a direction perpendicular to the optical axis; the at least one has, at a first portion, surface roughness larger than surface roughness of a second portion of which a thickness is thicker than the first portion; and a difference between the surface roughness of the first portion and the second portion is 1.0 nmRa or more in arithmetic average roughness.

### BACKGROUND

### Field of the Technology

The present disclosure relates to a mold, a lens, a lens unit, an information terminal, an imaging apparatus, and a molding method.

### Description of the Related Art

In recent years, with increasing magnification and miniaturization of imaging apparatuses, high precision and miniaturization of optical members have been required, and an aspherical lens (hereafter referred to as “gull lens”) having an inflection point within an effective diameter have been adopted. Japanese Patent Laid-Open No. 2015-26946 discloses a gull lens.

As a method of manufacturing an aspherical lens made of glass, there is a method of manufacturing a lens of a desired shape by performing the press-molding on a melted glass material using a mold. However, when molding the aspherical lens, there is a concern that the stress concentrates on a part of the lens at the time of mold release and the lens is cracked.

Japanese Patent Laid-Open No. 2007-99598 discloses a mold which reduces the crack of a lens at the time of molding by making the surface roughness of the center part of the mold smaller than that of other parts when molding a glass lens in which the curvature largely changes between the center part and other potions.

The aspherical lens having an inflection point within the effective diameter has room for improvement in optical characteristics. Further, in a case where the molding is performed on glass using a mold when manufacturing the aspherical lens having the inflection point within the effective diameter, the lens is apt to crack depending on the shape of the lens.

### SUMMARY

Therefore, according to a first aspect of the present disclosure, there is provided a technique capable of improving the optical characteristics of an aspheric lens. Further, according to a second aspect of the present disclosure, there is provided a technique capable of suppressing the occurrence of cracks when molding an aspheric lens.

A first aspect of the present disclosure is a lens comprising a first optically effective surface and a second optically effective surface which intersect an optical axis, wherein: at least one of the first optically effective surface and the second optically effective surface has an inflection point between an intersection with the optical axis and an effective region end; a distribution of thickness between the first optically effective surface and the second optically effective surface in a direction parallel to the optical axis has an extreme value at a position away from the optical axis in a direction perpendicular to the optical axis; the at least one of the first optically effective surface and the second optically effective surface has, at a first portion of the lens, surface roughness larger than surface roughness of a second portion of which a thickness is thicker than the first portion; and a difference between the surface roughness of the first portion and the surface roughness of the second portion is 1.0 nmRa or more in arithmetic average roughness.

A second aspect of the present disclosure is a mold comprising: a pair of a first member and a second member used for press-molding a lens having a first optically effective surface and a second optically effective surface intersecting an optical axis, wherein at least one of the first optically effective surface and the second optically effective surface has an inflection point between an intersection with the optical axis and an effective region end, and wherein a distribution of thickness between the first optically effective surface and the second optically effective surface in a direction parallel to the optical axis has an extreme value at a position away from the optical axis in a direction perpendicular to the optical axis, wherein at least one of the first member and the second member has, at a first correspondence portion corresponding to a first portion of the lens, surface roughness larger than surface roughness of a second correspondence portion corresponding to a second portion of the lens of which a thickness is thicker than the first portion.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram for illustrating an example of a lens and an example of a thickness distribution of the lens according to an embodiment 1 of the present disclosure.

FIG. 2 is an image diagram for illustrating a method of molding the lens using a mold according to the embodiment 1 of the present disclosure.

FIG. 3 is a diagram for explaining a measurement position of the surface roughness of the mold according to Embodiment 1 of the present disclosure.

FIG. 4A is a diagram for illustrating an example of the surface roughness of the mold according to the embodiment 1 of the present disclosure.

FIG. 4B is a diagram for illustrating an example of the surface roughness of the mold according to the embodiment 1 of the present disclosure.

FIG. 4C is a diagram for illustrating an example of the surface roughness of the mold according to the embodiment 1 of the present disclosure.

FIG. 4D is a diagram for illustrating an example of the surface roughness of the mold according to the embodiment 1 of the present disclosure.

FIG. 5 is a diagram for illustrating an example of a lens unit according to an embodiment 2 of the present disclosure.

FIG. 6 is a diagram for illustrating an example of an information terminal according to an embodiment 3 of the present disclosure.

FIG. 7 is a diagram for illustrating an example of an imaging device according to an embodiment 4 of the present disclosure.

### DESCRIPTION OF THE EMBODIMENTS

Further features of the present disclosure will become apparent from the following description of exemplary embodiments and examples with reference to the attached drawings. However, the dimensions, materials, shapes, and relative positions of the components described in the following embodiments and examples can be freely set and can be changed according to the configuration of an apparatus to which the present disclosure is applied or various conditions. In addition, the same reference numerals are used in the drawings to denote elements that are identical or functionally similar.

### Embodiment 1

### [Configuration of Lens]

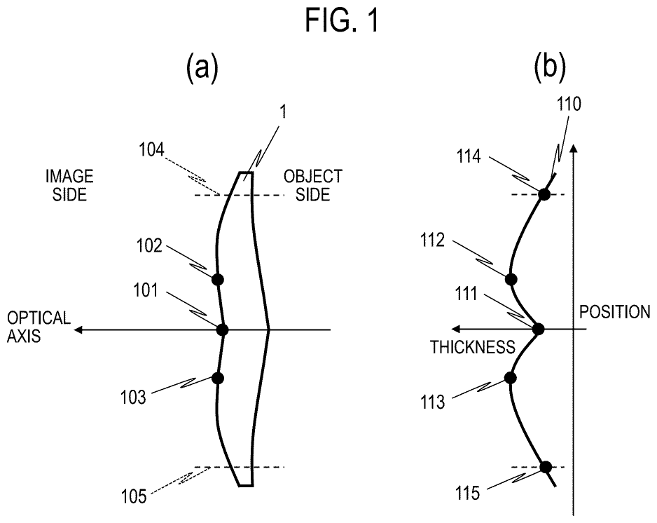

A lens according to an embodiment 1 of the present disclosure will be described with reference to FIG. 1. The lens has two optically effective surfaces (first optically effective surface and second optically effective surface), each of which intersects an optical axis. One optically effective surface of the two optically effective surface is a light incident surface and an optically effective surface on an object side, and is referred to as an object side surface. One optically effective surface is a light exit surface and an optically effective surface on an image side, and is referred to as an image side surface. The entire surface of optically effective surface is an effective region through which light rays that are effectively imaged pass. The effective region end of the lens means an end of the optically effective region of the lens, and the optically effective region of the lens means a region of the lens having predetermined optical characteristics. The light incident surface or the light exit surface of the lens may have an ineffective region through which light rays that are not effectively imaged pass. The surface of the lens may have an ineffective region through which light rays do not pass in an optical system. The boundary between the effective region and the ineffective region is the effective region end.

The lens according to the embodiment 1 can be molded using a mold, and may be a glass lens using a material such as borosilicate glass, lanthanum glass, or fluorophosphate glass. The lens according to the present embodiment can be molded using a mold, and may be a plastic lens using a material such as cyclic olefin polymer, polycarbonate, or acrylic resin.

The lens according to the present embodiment can be molded as a so-called gull lens having an inflection point in the effective diameter. Specifically, the gull lens has an inflection point on at least one contour line of the object side and the image side of the lens cross section including the optical axis and along optical axis, between the effective region end of the lens and the intersection of the contour line and the optical axis. That is, at least one of the object side surface and the image side surface has the inflection point between the effective region end and the intersection with the optical axis. In the gull lens, the distribution of thickness between the object side surface and the image side surface in a direction parallel to optical axis (optical axis direction) has an extreme value at a position that is away from the optical axis in a direction perpendicular to the optical axis (radial direction), that is, a position other than the intersection between the lens and the optical axis. The position having the extreme value is called an extreme value position. That is, a relationship (function) of the thickness at a position with respect to the position in the radial direction has an extreme value of thickness at the extreme value position.

(a) of FIG. 1 shows an example of the lens according to the embodiment 1, and (b) of FIG. 1 shows an example of thickness distribution of the lens according to the embodiment 1. The lens 1 according to the embodiment 1, as shown in (a) of FIG. 1, has an inflection point 102, 103 at a contour line on the image side of the lens cross section including an optical axis and along the optical axis between the effective region end 104, 105 of the lens and the intersection 101 between the contour line and the optical axis. Further, in the lens 1, as shown in (b) of FIG. 1, the thickness distribution 110 between an object side surface and an image side surface in a direction parallel to the optical axis has extreme value points 112, 113 other than the point 111 corresponding to the intersection between the lens and the optical axis. (b) of FIG. 1 also shows effective region end points 114, 115 of the thickness distribution 110 corresponding to the effective region ends 104, 105.

Note that the configuration of the lens 1 is an example, and the lens according to the embodiment 1 may have an inflection point at the contour line on the object side of the lens section including the optical axis and along the optical axis between the effective region end of the lens and the intersection between the contour line and the optical axis. Further, in the lens 1 shown in (a) of FIG. 1, a surface on the image side has a concave shape and a surface on the object side has a convex shape near the center. However, the shape of the lens according to the embodiment 1 is not limited to this. In the lens according to the embodiment 1, the surface on the image side may have a convex shape and the surface on the object side may have a concave shape, the surfaces on both sides may have a concave shape, or the surfaces on both sides may have a convex shape near the center.

Further, in the lens 1, surface roughness of at least one of the object side surface and the image side surface at a portion where the thickness of the lens 1 is relatively thin is larger than surface roughness at the other portion. In other words, surface roughness of at least one of the object side surface and the image side surface at a first portion of the lens 1 is larger than surface roughness at a second portion of which the thickness is thicker than the first portion.

As a shape having a large surface roughness, for example, a shape having a large arithmetic average roughness on a surface, a shape having a high spatial frequency of an extreme value of power spectral density (PSD) on the surface, and the like are considered. In a case where an evaluation index is Ra, a measurement range centering on a corresponding point is set as a region for measuring the surface roughness. The measurement range is preferably 10 μm or more, 25 μm or more, or 60 μm or more, and preferably 1000 μm or less, 600 μm or less, or 250 μm or less. In a case where the evaluation index is PSD, the region for measurement is preferably a square region of 600 μm² or more and 0.06 mm² or less with the corresponding point as the center. Not limited to this, the surface roughness within a square region of 100 μm² to 0.01 mm² or 0.01 mm² to 1 mm² with the corresponding point as the center may be used.

The power spectral density is a spectral function expressing the roughness as a power value per a unit frequency width so as not to depend on the frequency decomposition Δf. In this specification, the power spectral density (PSD) is expressed in logarithmic terms. The specification describes the spatial frequency of an extreme value of the PSD in the spatial frequency 6000 [1/mm] to 10,000 [1/mm]. However, the spatial frequency range of the PSD relating to the extreme value is not limited to the spatial frequency 6000 [1/mm] to 10,000 [1/mm], and may be changed according to a desired configuration.

Therefore, the lens 1 may have, for example, a configuration in which arithmetic the average roughness of at least one of the object side surface and the image side surface at a portion where the thickness of the lens 1 is relatively thin is larger than the arithmetic average roughness at the other portion. The lens 1 may also have, for example, a configuration in which the surface roughness based on the power spectral density and the spatial frequency of extreme value of power spectral density at the portion where the thickness of the lens 1 is relatively thin is higher than the spatial frequency of extreme value of power spectral density at the other portion, in the spatial frequency 6000 [1/mm] to 10,000 [1/mm] which is expressed by the power spectral density.

In the gull lens having a large thickness variation, there is a concern that the optical characteristics may deteriorate due to an expansion of light quantity distribution caused by an absorption amount of the transmitted light being large in the thicker portion and being small in the thinner portion in accordance with the Lambert-Beer law. In the lens 1 according to the embodiment 1, scattering in the thicker portion is small due to the small surface roughness of the thicker portion. Therefore, the reduction of the light quantity of the transmitted light is smaller in the thicker portion than in the thinner portion having the large surface roughness, and the expansion of light quantity distribution in the lens surface can be suppressed. In this regard, a significant difference in the surface roughness of the portions (the first portion and the second portion) to be compared within one optically effective surface may be 1.0 nmRa or more in the arithmetic average roughness. Two portions in which the difference in the surface roughness in the one optically effective surface is less than 1.0 nmRa in the arithmetic average roughness are not effective from the viewpoint of suppressing the expansion of light quantity distribution in the optically effective surface. The difference in the surface roughness of the portions (the first portion and the second portion) to be compared within one optically effective surface may be 10 nmRa or less in the arithmetic average roughness. If the difference in the surface roughness exceeds 10 nmRa in the arithmetic average roughness, the degree of freedom of lens design for obtaining desired optical characteristics may be reduced.

Further, in a case where the press molding using a mold is performed for a gull lens having the large thickness variation, there is a concern that the stress tends to accumulate in a part of the lens at the time of mold release due to a difference in the amount of thermal contraction proportional to the thickness of the lens, and that cracking may occur. In the lens 1 according to the embodiment 1, when the press molding is performed, the progress of mold release is accelerated due to the large surface roughness in the portion having a thin thickness. By accelerating the progress of mold release in the portion where the thickness of the lens 1 is thin, the progress of mold release of the lens 1 can be controlled, a sudden change in the stress during molding can be suppressed, and the cracking of the lens 1 during molding can be suppressed.

### [Method of Molding a Glass Lens]

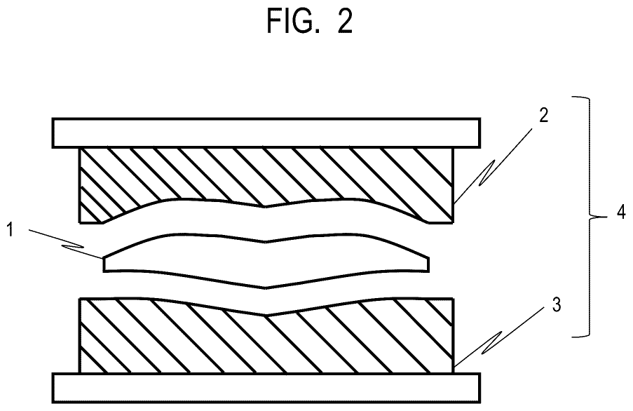

Next, with reference to FIG. 2, a mold for heating and softening a glass member, and performing the press-molding on the glass member, and a method of molding a glass lens will be described. FIG. 2 is an image view for explaining a molding method using a mold according to the embodiment 1.

A mold 4 according to the embodiment 1 includes a first member 2 and a second member 3. The first member 2 and the second member 3 are mold members for transferring the shapes of optically effective surfaces of the lens 1 to be molded, and the shaped of the members are cylindrical. Therefore, the lens 1 molded using the mold 4 can have a shape corresponding to the shapes of the first member 2 and the second member 3 in contact with the lens 1 during the molding. For example, the lens 1 molded by using the mold 4 may have surface roughness corresponding to the surface roughness of the first member 2 described below on a surface in contact with the first member 2 during the molding. Similarly, the lens 1 molded by using the mold 4 may have surface roughness corresponding to the surface roughness of the second member 3 described below on a surface in contact with the second member 3 during molding. The first member 2 and the second member 3 may be formed by using, for example, a cemented carbide as a material in order to suppress mold wear. Further, a material harder than the cemented carbide may be formed on the surfaces of the first member 2 and the second member 3. Note that the member shapes of the first member 2 and the second member 3 are not limited to the cylindrical shape, and may be any shape according to a desired configuration.

The mold 4 has a drive system (not shown), and the lens 1 can be formed by moving at least one of the first member 2 and the second member 3 in the vertical direction during the press-molding. Here, a method of press-molding will be described as an example of a method of molding the lens 1 using the mold 4 according to the embodiment 1. Note that the following molding method is only an example, and the lens 1 may be molded by any known molding method capable of forming the shape of both surfaces of the lens using mold members.

In the molding method according to the embodiment 1, first, the mold 4 is heated, and then a preform of the lens 1 is arranged in the mold 4. Then, the mold 4 and the preform are further heated to soften the preform until the viscosity of the preform becomes a state suitable for the press-molding. Next, at least one of the first member 2 and the second member 3 is moved in the vertical direction to press the preform, and the mold 4 is brought into contact with the preform to mold the preform into a desired shape of the lens 1. Finally, the temperature of the mold 4 is lowered, and when the temperature of the mold 4 becomes lower than a predetermined temperature, the applied load is unloaded. When the load is unloaded, the lens 1 which has been pressed until then can be deformed, and the lens 1 can be released from the mold 4.

The at least one of the first member 2 and the second member 3 has, at a portion corresponding to the portion where the thickness of the lens 1 is relatively thin, surface roughness larger than surface roughness of the other portion of the at least one. In other words, the at least one has, at a portion (first correspondence portion) corresponding to the first portion of the lens 1, surface roughness larger than surface roughness of a portion (second correspondence portion) corresponding to the second portion thicker than the first portion of the lens 1 after the molding. The portion corresponding to the portion of the lens 1 (e.g., the portion having a relatively thin thickness of the lens 1 after the molding) in at least one of the first member 2 and the second member 3 may be a portion in contact with the portion of the lens 1 when the lens 1 is molded. Here, the difference between the surface roughness of the first correspondence portion and the surface roughness of the second correspondence portion may be 1.0 nmRa or more in the arithmetic average roughness. The difference between the surface roughness of the first correspondence portion and the surface roughness of the second correspondence portion may be 10 nmRa or less in the arithmetic average roughness.

More specifically, the at least one of the first member 2 and the second member 3 according to the embodiment 1 has, at a portion corresponding to a point where the thickness of the glass lens is minimum among a point group including a point corresponding to an intersection between the glass lens and the optical axis, an effective region end point, and a point having an extreme value in the thickness distribution of the glass lens, surface roughness larger than surface roughness at a portion corresponding to a point where the thickness of the glass lens is maximum among the point group.

With such a configuration, in the mold 4 according to the embodiment 1, when the lens 1 is press-molded, the progress of mold release is accelerated due to the large surface roughness at the portion corresponding to the portion where the thickness of the lens 1 is thin. By accelerating the progress of mold release at the portion where the thickness of the lens 1 is thin, the progress of mold release of the lens 1 can be controlled, a sudden change in the stress at the time of molding can be suppressed, cracking of the lens 1 at the time of molding can be suppressed, and a glass lens in which the expansion of light quantity distribution is suppressed can be manufactured.

The at least one of the first member 2 and the second member 3 may have, for example, at the portion corresponding to the portion where the thickness of the lens 1 is relatively thin, arithmetic average roughness larger than arithmetic average roughness of the other portion in the at least one. The surface roughness of the at least one portion may have a configuration in which, for example, a spatial frequency of an extreme value of a power spectral density at a portion corresponding to the portion where the thickness of the lens 1 is relatively thin is higher than a spatial frequency of an extreme value of a power spectral density at the other portion in the at least one, in a spatial frequency 6000 [1/mm] to 10,000 [1/mm] expressed in power spectral density.

The surface roughness of the at least one of the first member 2 and the second member 3 may be changed stepwise. For example, the surface roughness of the at least one of the first member 2 and the second member 3 may be changed in two steps: at a portion corresponding to a portion having a relatively thin thickness of the lens 1 after the molding, and at portion other than the portion (the other portion). The surface roughness of the at least one of the first member 2 and the second member 3 may be changed in three steps or more. Since the surface roughness of the mold member is changed stepwise according to the thickness of the lens 1 after the molding, the timing of the mold release progress can be more appropriately controlled. As a result, the sudden change in the stress during the molding can be suppressed, the occurrence of a crack of the glass lens can be suppressed, and the glass lens in which the expansion of the light quantity distribution is suppressed can be manufactured.

Further, the at least one of the first member 2 and the second member 3 according to embodiment 1 may have surface roughness smaller than the surface roughness of the portion corresponding to the first portion of the lens 1 after the molding and larger than the surface roughness of the portion corresponding to the second portion at a portion corresponding to a third portion which is thicker than the first portion and thinner than the second portion. According to this configuration, since the surface of the mold member has surface roughness corresponding to the relative thickness of the lens 1 after the molding, the timing of the progress of mold release progress can be more appropriately controlled. As a result, the sudden change in the stress during the molding can be suppressed, the occurrence of the crack of the glass lens can be suppressed, and the glass lens in which the expansion of the light quantity distribution is suppressed can be manufactured.

The surface roughness of the at least one of the first member 2 and the second member 3 may be continuously changed. For example, the at least one of the first member 2 and the second member 3 may have surface roughness corresponding to the thickness of the lens 1 after the molding. More specifically, the at least one of the first member 2 and the second member 3 may have surface roughness such that the thinner the thickness of the lens 1 after the molding, the larger the surface roughness at a portion corresponding to the portion of the lens 1. According to such a configuration, since the surface of the mold member has the surface roughness corresponding to the relative thickness of the lens 1 after the molding, the timing of the progress of mold release can be more appropriately controlled. As a result, the sudden change in the stress can be suppressed during the molding, the occurrence of the crack of the glass lens can be suppressed, and the glass lens in which the expansion of the light quantity distribution is suppressed can be manufactured.

The method for applying the surface roughness to the mold 4 may include, for example, the laser processing, the ion beam processing, the polishing processing, and the blasting. However, the method for applying the surface roughness to the mold 4 is not limited to these, and any method may be used according to a desired configuration. Further, other than the transfer of the surface roughness by molding using the mold 4, any method for applying the surface roughness to the lens 1 may be used according to a desired configuration, such as the laser processing, the ion beam processing, the polishing processing, and the blasting.

The surface roughness of the lens 1 including the surface roughness at the thickest point and the surface roughness at the thinnest point of the lens 1 can be set to, for example, 2 nmRa to 12 nmRa in the arithmetic average roughness. In such a case, the lens 1 can have a preferable transmittance to be used as an optical lens. The difference between the maximum thickness and the minimum thickness of the lens 1 can be set to, for example, 0.4 mm to 5.0 mm. By setting the difference between the maximum thickness and the minimum thickness of the lens 1 to 5.0 mm or less, it can be facilitated to adjust the surface roughness of the lens 1 to make the transmittance of the lens 1 uniform. Further, by setting the difference between the maximum thickness and the minimum thickness of the lens 1 to 0.4 mm or more, when the lens 1 is used as an optical lens, the effect of the lens having a gull shape (for example, the amount of light bending, etc.) can be appropriately exerted.

### [Method of Measuring Light Amount Distribution]

Next, a method of measuring the light amount distribution of the lens 1 according to embodiment 1 will be described. First, light emitted from the light source is passed through the lens 1 and projected onto a projection surface. Then, the projected light is measured using, for example, a two-dimensional imaging color luminance meter to obtain the light amount distribution. An illuminometer or a luminance meter may be used for the measurement. In addition, a lens unit may be formed by using the molded lens 1, and a light quantity distribution may be obtained from an imaging result.

### [Method for Evaluating the Surface Roughness of a Mold]

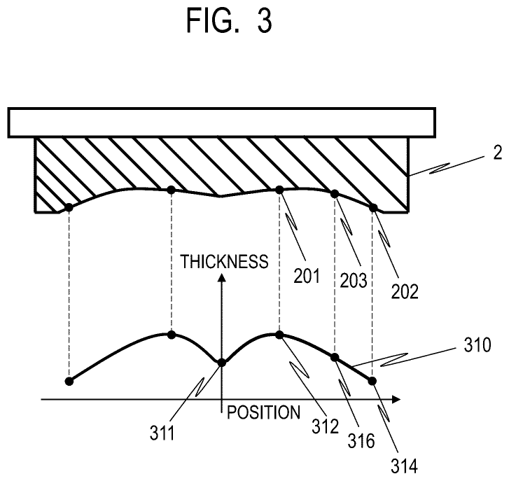

Next, an evaluation method for evaluating the surface roughness of the mold 4 according to the embodiment 1 will be described. FIG. 3 is a diagram for explaining a measurement position of the surface roughness of the mold 4 according to the embodiment 1, and is a sectional view of an example of the first member 2 of the mold 4 along the optical axis of the lens 1 to be molded. The thickness distribution 310 shown in FIG. 3 indicates a thickness distribution of the effective region within the thickness distribution 110 shown in FIG. 1.

First, the thickness distribution 310 in the optical axis direction of the lens 1 after the molding is obtained. The method of obtaining the thickness distribution 310 may be any known method, and for example, the thickness distribution 310 may be obtained by using a known thickness measuring apparatus. On the thickness distribution 310, as shown in FIG. 3, there is a point group including a point 311 corresponding to the intersection with the optical axis, an effective region end point 314, and an extreme value point 312 having an extreme value. A position in the radial direction corresponding to the point 311 corresponding to the intersection with the optical axis is an optical axis position. Further, a position in the radial direction corresponding to the extreme value point 312 is an extreme value position. During the molding, the lens 1 contacts, at positions corresponding to the thickest point and the thinnest point among the positions in the radial direction corresponding to the point group, the point 201 corresponding to the thickest point and the point 202 corresponding to the thinnest point on the surface of the first member 2. Therefore, the point 201 corresponding to the thickest point and the point 202 corresponding to the thinnest point of the lens 1 are set as points for evaluating the surface roughness of the first member 2. Further, a point 203 freely selected from positions other than the point 201 corresponding to the thickest point and the point 202 corresponding to the thinnest point within the effective diameter is set as the point for evaluating the surface roughness of the first member 2. The point 203 corresponds to a point 316 on the thickness distribution 310.

Next, the surface roughness at the points 201, 202, 203 of the first member 2 is measured by, for example, a contact type roughness measuring instrument. As a result, the arithmetic average roughness (Ra) or the power spectral density (PSD) at each of the points 201, 202, 203 of the first member 2 of the mold 4 is evaluated.

The evaluation method for evaluating the surface roughness of the first member 2 has been described. The surface roughness of the second member 3 may be evaluated by a similar method. The evaluation index of the surface roughness is not limited to the arithmetic surface roughness or the power spectral density, and may be any other known evaluation index. Depending on the shape of the sample to be evaluated (such as the mold 4), the measurement may be difficult due to interference between the sample and the measuring instrument. In such a case, the evaluation may be performed by substituting a plane sample to which the roughness has been applied under similar conditions.

Hereinafter, the lens, the mold, and the molding method according to the embodiment 1 of the present disclosure will be described with reference to examples and comparative examples. As the examples, examples 1 to 5, in which a glass lens having desired arithmetic average roughness is obtained by intentionally applying the desired arithmetic average roughness to the surface of the mold 4, and examples 6 to 10, in which a glass lens having a desired PSD is obtained by intentionally applying the desired PSD to the surface of the mold 4, will be described. As the comparative examples, comparative examples 1 to 5, in which a glass lens having a desired arithmetic average roughness is obtained by intentionally applying the desired arithmetic average roughness to the surface of the mold 4, and comparative examples 6 to 10, in which a glass lens having a desired PSD is obtained by intentionally applying the desired PSD to the surface of the mold 4, will be described.

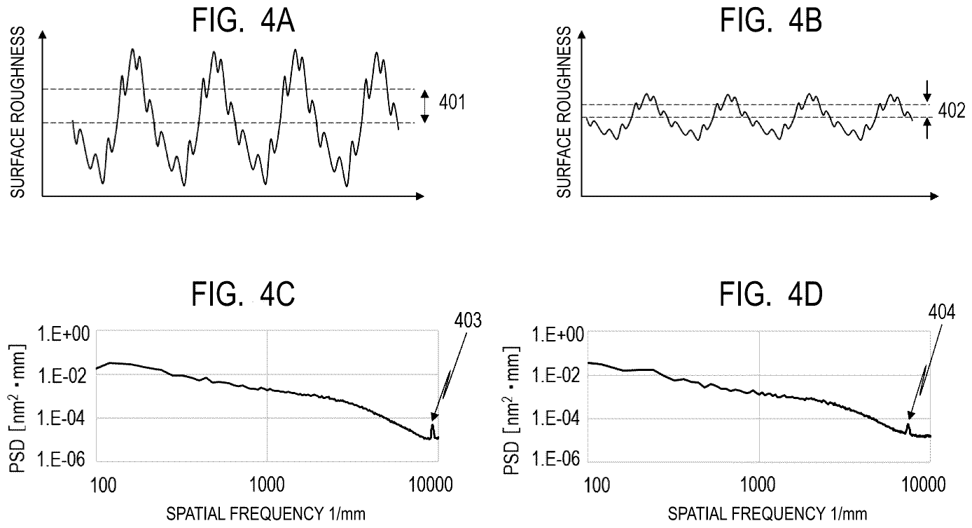

The surface roughness applying process to the mold 4 according to the embodiment 1 will be described below with reference to FIG. 4A to FIG. 4D. FIG. 4A and FIG. 4B show examples of the arithmetic average roughness at points on the mold surface according to the embodiment 1, and FIG. 4C and FIG. 4D show examples of the logarithmically expressed PSD at points on the mold surface according to the embodiment 1.

In examples 1 to 5, the surface roughness applying process to the mold 4 was performed so that arithmetic average roughness 401, shown in FIG. 4A, at a point on the mold surface in contact with the thinnest point of the lens during the molding is larger than arithmetic average roughness 402, shown in FIG. 4B, at a point on the mold surface in contact with the thickest point of the lens during the molding. In Examples 6 to 10, the surface roughness applying process to the mold 4 was performed so that a spatial frequency of an extreme value 403 of PSD in a spatial frequency 6000 [1/mm] to 10,000 [1/mm], shown in FIG. 4C, at a point on the mold surface in contact with the thinnest point of the lens during the molding is higher than a spatial frequency of an extreme value 404 of PSD in the same spatial frequency range, shown in FIG. 4D, at a point on the mold surface in contact with the thickest point of the lens during the molding. Note that the present disclosure is not limited to the following examples.

First, the examples 1 to 5 and the comparative examples 1 to 5 in which a desired arithmetic average roughness is applied as the surface roughness of the mold 4 will be described.

### Example 1

In the example 1, a glass lens having concave shapes on the both-sides near the center was molded. A pair of molds 4 were prepared so that the thickness of the thickest point of the lens became 3.5 mm, the thickness of the thinnest point became 1.2 mm, and the thickness of a point freely selected from the positions other than the thickest point and the thinnest point became 2.0 mm by the molding.

In the example 1, the process for applying the surface roughness was performed on both the first member 2 and the second member 3 of the mold 4. Specifically, the process was performed so that the surface roughness of the mold 4 at the point in contact with the thickest point of the lens after the molding became 2.0 nmRa, the surface roughness of the mold 4 at the point in contact with the thinnest point of the lens became 7.0 nmRa, and the surface roughness of the mold 4 at the point in contact with the freely selected point of the lens became 3.4 nmRa.

The molding was performed as follows using the mold 4. Optical glass for glass molding having a glass transition temperature of 615° C. was used as the preform. An infrared heater was used as a heater for heating the mold 4 and the preform. First, the temperature of the mold 4 was heated to a first temperature (580° C.), and then the preform was arranged in the mold. Thereafter, the mold 4 and the preform were heated to a second temperature (680° C.) higher than the first temperature to soften the preform until the viscosity of the preform became to a state suitable for the press molding. Next, the mold 4 and the preform were brought into contact by pressing with a first load (4000 N) to mold the preform into a desired glass lens shape. Finally, when the mold 4 reached a temperature (580° C.) lower than the second temperature, the applied load is unloaded. When the load was unloaded, the glass lens which has been pressed until then could be deformed, and the glass lens was released from the mold 4.

In the example 1, the glass lens without cracks was molded under these molding conditions. When the surface roughness of the thickest point and the thinnest point of the molded lens was measured, it was confirmed that the surface roughness of the thinnest point was larger than that of the thickest point, and it was also confirmed that there was substantially no light quantity distribution. Furthermore, when a lens unit was manufactured using the molded lens and mounted on an information terminal, it was confirmed that good imaging performance was obtained.

### Example 2

In the example 2, a glass lens having a concave shape on one-side and a convex shape on one-side near the center was molded. A pair of molds 4 were prepared so that the thickness of the thickest point of the lens became 1.0 mm, the thickness of the thinnest point became 0.6 mm, and the thickness of a point freely selected from the positions other than the thickest point and the thinnest point became 0.7 mm by the molding.

In the example 2, the process for applying the surface roughness was performed on both the first member 2 and the second member 3 of the mold 4. Specifically, the process was performed so that the surface roughness of the mold 4 at the point in contact with the thickest point of the lens after the molding became 3.1 nmRa, the surface roughness of the mold 4 at the point in contact with the thinnest point of the lens became 5.6 nmRa, and the surface roughness of the mold 4 at the point in contact with the freely selected point of the lens became 4.8 nmRa.

The molding was performed by the same method as in the example 1 using this mold 4. Also in the example 2, a glass lens without cracks was molded. When the roughness of the thickest point and the thinnest point of the molded lens was measured, it was confirmed that the roughness of the thinnest point was larger than that of the thickest point, and it was also confirmed that the light intensity distribution was small (narrow).

### Example 3

In the example 3, a glass lens having a convex shape on both-sides near the center was molded. A pair of molds 4 were prepared so that the thickness of the thickest point of the lens became 4.6 mm, the thickness of the thinnest point was 0.5 mm, and the thickness of a point freely selected from the positions other than the thickest point and the thinnest point became 3.0 mm by the molding.

In the example 3, the process for applying the surface roughness was performed on only the first member 2 of the mold 4. Specifically, the process was performed so that the surface roughness of the mold 4 at the point in contact with the thickest point of the lens after the molding became 5.7 nmRa, the surface roughness of the mold 4 at the point in contact with the thinnest point of the lens became 9.5 nmRa, and the surface roughness of the mold 4 at the point in contact with the freely selected point of the lens became 7.2 nmRa.

The molding was performed by the same method as in the example 1 using this mold 4. Also in the example 3, a glass lens without cracks was molded. When the roughness of the thickest point and the thinnest point of the molded lens was measured, it was confirmed that the roughness of the thinnest point was larger than that of the thickest point, and it was also confirmed that there was substantially no light quantity distribution.

### Example 4

In the example 4, a glass lens having a concave shape on one-side and a convex shape on one-side near the center was molded. A pair of molds 4 were prepared so that the thickness of the thickest point of the lens became 5.3 mm, the thickness of the thinnest point became 2.1 mm, and the thickness of a point freely selected from the positions other than the thickest point and the thinnest point became 3.6 mm by the molding.

In the example 4, the process for applying the surface roughness was performed on only the first member 2 of the molds 4. Specifically, the process was performed so that the surface roughness of the mold 4 at the point in contact with the thickest point of the lens after the molding became 2.4 nmRa, the surface roughness of the mold 4 at the point in contact with the thinnest point of the lens became 6.9 nmRa, and the surface roughness of the mold 4 at the point in contact with the freely selected point of the lens became 10.6 nmRa.

The molding was performed by the same method as in the example 1 using this mold 4. In the example 4, a few cracks were observed. However, the molding was performed at a level that did not cause any problem in terms of specifications. In addition, when the roughness of the thickest point and the thinnest point of the molded lens was measured, it was confirmed that the roughness of the thinnest point was larger than that of the thickest point, and it was also confirmed that there was substantially no light quantity distribution.

### Example 5

In the example 5, a glass lens having a concave shape on one-side and a convex shape on one-side near the center was molded. A pair of molds 4 were prepared so that the thickness of the thickest point of the lens became 2.3 mm, the thickness of the thinnest point became 1.4 mm, and the thickness of a point freely selected from the positions other than the thickest point and the thinnest point became 1.7 mm by the molding.

In the example 5, the process for applying the surface roughness was performed only the second member 3 of the mold 4. Specifically, the process was performed so that the surface roughness of the mold 4 at the point in contact with the thickest point of the lens after the molding became 3.8 nmRa, the surface roughness of the mold 4 at the point in contact with the thinnest point of the lens became 6.5 nmRa, and the surface roughness of the mold 4 at the point in contact with the freely selected point became 1.1 nmRa.

The molding was performed by the same method as in the example 1 using this mold 4. In the example 5, a few cracks were observed. However, the molding was performed at a level that did not cause any problem in terms of specifications. In addition, when the roughness of the thickest point and the thinnest point of the molded lens was measured, it was confirmed that the roughness of the thinnest point was larger than the roughness of the thickest point, and it was also confirmed that the light quantity distribution was small.

### Comparative Example 1

In the comparative example 1, the molding of a glass lens having the same shape as in the example 1 was performed. In the comparative example 1, the process for applying the surface roughness was performed on both the first member 2 and the second member 3 of the mold 4. Specifically, the process was performed so that the surface roughness of the mold 4 at the point in contact with the thickest point of the lens after the molding became 8.0 nmRa, the surface roughness of the mold 4 at the point in contact with the thinnest point of the lens became 4.0 nmRa, and the surface roughness of the mold 4 at the point in contact with the freely selected point of the lens became 3.2 nmRa.

The molding was performed by the same method as in the example 1 using the mold 4. In the comparative example 1, a few cracks were also observed. However, the molding was performed at a level that did not cause any problem in terms of specifications. When the roughness of the thickest point and the thinnest point of the molded lens was measured, it was confirmed that the roughness of the thinnest point was larger than the roughness of the thickest point, but the light quantity distribution was large, which caused a problem in terms of specifications.

### Comparative Example 2

In the comparative example 2, the molding of a glass lens having the same shape as in the example 2 was performed. In the comparative example 2, the process for applying the surface roughness was performed on both the first member 2 and the second member 3 of the mold 4. Specifically, the process was performed so that the surface roughness of the mold 4 at the point in contact with the thickest point of the lens after the molding became 3.1 nmRa, the surface roughness of the mold 4 at the point in contact with the thinnest point of the lens became 1.2 nmRa, and the surface roughness of the mold 4 at the point in contact with the freely selected point of the lens became 1.5 nmRa.

The molding was performed by the same method as in the example 1 using this mold 4. In the comparative example 2, finally when the temperature of the mold 4 was lower than the second temperature (580° C.), the applied load was unloaded, but cracking occurred and the molding could not be completed. Since the molding could not be completed, the light quantity distribution could not be measured.

### Comparative Example 3

In the comparative example 3, the molding of a glass lens having the same shape as in the example 3 was performed. In the comparative example 3, the process for applying the surface roughness was performed on only the first member 2 of the mold 4. Specifically, the process was performed so that the surface roughness of the mold 4 at the point in contact with the thickest point of the lens after the molding became 5.7 nmRa, the surface roughness of the mold 4 at the point in contact with the thinnest point of the lens became 2.1 nmRa, and the surface roughness of the mold 4 at the point in contact with the freely selected point of the lens became 3.3 nmRa.

The molding was performed by the same method as in the example 1 using this mold 4. In the comparative example 3, finally when the temperature of the mold 4 was lower than the second temperature (580° C.), the applied load was unloaded, but cracking occurred and the molding could not be completed. Since the molding could not be completed, the light quantity distribution could not be measured.

### Comparative Example 4

In the comparative example 4, a glass lens having the same shape as in the example 4 was molded. In the comparative example 4, the process for applying the surface roughness was performed on only the first member 2 of the mold 4. Specifically, the process was performed so that the surface roughness of the mold 4 at the point in contact with the thickest point of the lens of the molding became 12.4 nmRa, the surface roughness of the mold 4 at the point in contact with the thinnest point of the lens became 6.9 nmRa, and the surface roughness of the mold 4 at the point in contact with the freely selected point of became 10.6 nmRa.

The molding was performed by the same method as in the example 1 using this mold 4. In the comparative example 4, finally, when the temperature of the mold 4 was lower than the second temperature (580° C.), the applied load was unloaded, but cracking occurred and molding could not be completed. Since the molding could not be completed, the light quantity distribution could not be completed.

### Comparative Example 5

In the comparative example 5, the molding of a glass lens having the same shape as in the example 5 was performed. In the comparative example 5, the process for applying the surface roughness was performed on only the second member 3 of the mold 4. Specifically, the process was performed so that the surface roughness of the mold 4 at the point in contact with the thickest point of the lens after the molding became 7.8 nmRa, the surface roughness of the mold 4 at the point in contact with the thinnest point of lens became 6.5 nmRa, and the surface roughness of the mold 4 at the point in contact with the freely selected point of the lens became 1.1 nmRa.

The molding was performed by the same method as in the example 1 using this mold 4. In the comparative example 5, finally, when the temperature of the mold 4 was lower than the second temperature (580° C.), the applied load was unloaded, but cracking occurred and the molding could not be completed. Since the molding could not be completed, the light quantity distribution could not be measured.

The following Table 1 shows the shape of the glass lens, the surface roughness measurement result of the mold 4, the light quantity distribution of the lens, and the result of cracking during the molding (degree of cracking) according to the examples 1 to 5 and the comparative examples 1 to 5. As the evaluation criterion of the light quantity distribution of the lens, C is defined as a case where the light quantity distribution cannot be confirmed, B is defined as a case where the light quantity distribution can be confirmed to some extent but there is no problem in terms of specifications, and A is defined as a case where the light quantity distribution with a problem in terms of specifications can be confirmed. In addition, as the evaluation criterion of cracks at the time of molding, C is defined as a case in which no cracks can be confirmed, B is defined as a case in which some cracks can be confirmed but there is no problem in terms of specifications, and A is defined as a case in which cracks can be confirmed at a level that there is a problem in terms of specifications.

TABLE 1

| | | | | | | Surface | Surface | Surface | | |
|---|---|---|---|---|---|---|---|---|---|---|
| | | | | | | roughness | roughness | roughness | | |
| | | | | | | of mold at | of mold at | of mold at | | |
| | | | | | | point in | point in | point in | | |
| | | Surface(s) | Thickness | Thickness | Thickness | contact with | contact with | contact with | Light | |
| | Shape near | to which | of thickest | of thinnest | of freely | thickest | thinnest | freely | quantity | |
| | the center | roughness | point of | point of | selected | point of | point of | selected | distri- | Degree of |
| | of lens | is applied | lens [mm] | lens [mm] | point [mm] | lens [nmRa] | lens [nmRa] | point [nmRa] | bution | cracking |
| Example 1 | Concave on | First member and | 3.5 | 1.2 | 2 | 2 | 7 | 3.4 | C | C |
| | both-sides | Second member | | | | | | | | |
| Example 2 | Concave on | First member and | 1 | 0.6 | 0.7 | 3.1 | 5.6 | 4.8 | B | C |
| | one-side | Second member | | | | | | | | |
| | Convex on | | | | | | | | | |
| | one-side | | | | | | | | | |
| Example 3 | Convex on | First member | 4.6 | 0.5 | 3 | 5.7 | 9.5 | 7.2 | C | C |
| | both-sides | | | | | | | | | |
| Example 4 | Concave on | First member | 5.3 | 2.1 | 3.6 | 2.4 | 6.9 | 10.6 | C | B |
| | one-side | | | | | | | | | |
| | Convex on | | | | | | | | | |
| | one-side | | | | | | | | | |
| Example 5 | Concave on | Second member | 2.3 | 1.4 | 1.7 | 3.8 | 6.5 | 1.1 | B | B |
| | one-side | | | | | | | | | |
| | Convex on | | | | | | | | | |
| | one-side | | | | | | | | | |
| Comparative | Concave on | First member and | 3.5 | 1.2 | 2 | 8 | 4 | 3.2 | A | B |
| Example 1 | both-sides | Second member | | | | | | | | |
| Comparative | Concave on | First member and | 1 | 0.6 | 0.7 | 3.1 | 1.2 | 1.5 | — | A |
| Example 2 | one-side | Second member | | | | | | | | |
| | Convex on | | | | | | | | | |
| | one-side | | | | | | | | | |
| Comparative | Convex on | First member | 4.6 | 0.5 | 3 | 5.7 | 2.1 | 3.3 | — | A |
| Example 3 | both-sides | | | | | | | | | |
| Comparative | Concave on | First member | 5.3 | 2.1 | 3.6 | 12.4 | 6.9 | 10.6 | — | A |
| Example 4 | one-side | | | | | | | | | |
| | Convex on | | | | | | | | | |
| | one-side | | | | | | | | | |
| Comparative | Concave on | Second member | 2.3 | 1.4 | 1.7 | 7.8 | 6.5 | 1.1 | — | A |
| Example 5 | one-side | | | | | | | | | |
| | Convex on | | | | | | | | | |
| | one-side | | | | | | | | | |

In the examples 1 to 5, as shown in Table 1, it was possible to suppress the expansion of the light quantity distribution. Therefore, it was found that the light quantity distribution could be suppressed in a configuration in which at least one surface of the lens 1 has, at a portion where the thickness of the lens 1 after the molding is relatively thin, the surface roughness larger than the surface roughness of the other portion.

Further, in the examples 1 to 5, as shown in Table 1, it the occurrence of cracks could be suppressed. Therefore, it was found that the occurrence of cracks could be suppressed in a configuration in which at least one of the first member 2 and the second member 3 has, at a portion corresponding to a portion where the thickness of the lens 1 after the molding is relatively thin, the surface roughness larger than the surface roughness of the other portion.

In addition, in the examples 1 to 3, the occurrence of cracks could be further suppressed. For this reason, it was found that the occurrence of cracks could be further suppressed in a configuration in which the at least one has, at a portion corresponding to the third portion which is thicker than the first portion and thinner than the second portion of the lens 1 after the molding, the surface roughness smaller than the surface roughness of the portion corresponding to the first portion and larger than the surface roughness of the portion corresponding to the second portion.

Next, the examples 6 to 10 and the comparative examples 6 to 10 in which a desired PSD is applied as the surface roughness of the mold 4 will be described.

### Example 6

In the example 6, a glass lens having a concave shape on both-sides near the center was molded. A pair of molds 4 were prepared so that the thickness of the thickest point of the lens became 3.5 mm, the thickness of the thinnest point became 1.2 mm, and the thickness of a point freely selected from the positions other than the thickest point and the thinnest point became 2.0 mm by the molding.

In the example 6, the process for applying the surface roughness was performed on both the first member 2 and the second member 3 of the mold 4. Specifically, the process was performed so that the spatial frequency of extreme value of PSD in the spatial frequency 6000 [1/mm] to 10,000 [1/mm] on the mold surface at the point in contact with the thickest point of the lens after the molding became 7584 [1/mm], the spatial frequency of extreme value of PSD in the spatial frequency 6000 [1/mm] to 10,000 [1/mm] on the mold surface at the point in contact with the thinnest point of the lens became 9505 [1/mm], and the spatial frequency of extreme value of PSD in the spatial frequency 6000 [1/mm] to 10,000 [1/mm] on the mold surface at the point in contact with freely selected point of lens became 8546 [1/mm].

The molding was performed by the same method as in the example 1 using this mold 4. In the example 6, a glass lens without cracks was molded. In addition, when the spatial frequency of extreme value of PSD in the spatial frequency 6000 [1/mm] to 10,000 [1/mm] on the surface of the molded lens was measured at the thickest and thinnest points, it was confirmed that the spatial frequency of extreme value of PSD at the thinnest point was higher than the spatial frequency of extreme value of PSD at the thickest point, and it was also confirmed that there was no light quantity distribution. Furthermore, when a lens unit was manufactured using the molded lens and mounted on an information terminal, it was confirmed that good imaging performance was obtained.

### Example 7

In the example 7, a glass lens having a concave shape on one-side and a convex shape on one-side near the center was molded. A pair of molds 4 were prepared so that the thickness of the thickest point of the lens became 1.0 mm, the thickness of the thinnest point became 0.6 mm, and the thickness of a point freely selected from the positions other than the thickest point and the thinnest point became 0.7 mm by the molding.

In the example 7, the process for applying the surface roughness was performed on both the first member 2 and the second member 3 of the mold 4. Specifically, the process was performed so that the spatial frequency of extreme value of PSD in the spatial frequency 6000 [1/mm] to 10,000 [1/mm] on the mold surface at the point in contact with the thickest point of the lens after the molding became 7986 [1/mm], the spatial frequency of extreme value of PSD in the spatial frequency 6000 [1/mm] to 10,000 [1/mm] on the mold surface at the point in contact with the thinnest point of the lens became 8765 [1/mm], and the spatial frequency of extreme value of PSD in the spatial frequency 6000 [1/mm] to 10,000 [1/mm] on the mold surface at the point in contact with the freely selected point of lens became 8454 [1/mm].

The molding was performed by the same method as in the example 1 using this mold 4. Also in the example 7, a glass lens without cracks was molded. In addition, when the spatial frequency of extreme value of PSD in the spatial frequency 6000 [1/mm] to 10,000 [1/mm] of the surface of the molded lens was measured at the thickest point and the thinnest point, it was confirmed that the spatial frequency of extreme value of PSD at the thinnest point was higher than the spatial frequency of extreme value of PSD at the thickest point, and it was also confirmed that the light quantity distribution was small.

### Example 8

In the example 8, a glass lens having a convex shape on both-sides near the center was molded. A pair of molds 4 were prepared so that the thickness of the thickest point of the lens became 4.6 mm, the thickness of the thinnest point became 0.5 mm, and the thickness of a point freely selected from the positions other than the thickest point and the thinnest point became 3.0 mm by the molding.

In the example 8, the process for applying the surface roughness was performed on only the first member 2 of the mold 4. Specifically, the process was performed so that the spatial frequency of extreme value of PSD in the spatial frequency 6000 [1/mm] to 10,000 [1/mm] on the mold surface at the point in contact with the thickest point of the lens after the molding became 6954 [1/mm], the spatial frequency of extreme value of PSD in the spatial frequency 6000 [1/mm] to 10,000 [1/mm] on the mold surface at the point in contact with the thinnest point of the lens became 7561 [1/mm], and the spatial frequency of extreme value of PSD in the spatial frequency 6000 [1/mm] to 10,000 [1/mm] on the mold surface at the point in contact with the freely selected point of the lens became 7254 [1/mm].

The molding was performed by the same method as in the example 1 using this mold 4. Also in the example 8, a glass lens without cracks was molded. In addition, when the spatial frequency of extreme value of PSD in the spatial frequency 6000 [1/mm] to 10,000 [1/mm] of the surface of the molded lens was measured at the thickest and thinnest points, it was confirmed that the spatial frequency of extreme value of PSD at the thinnest point was higher than the spatial frequency of extreme value of PSD at the thickest point, and it was also confirmed that there was no light quantity distribution.

### Example 9

In the example 9, a glass lens having a concave shape on one-side and a convex shape on one-side near the center was molded. A pair of molds 4 were prepared so that the thickness of the thickest point of the lens became 5.3 mm, the thickness of the thinnest point became 2.1 mm, and the thickness of a point freely selected from the positions other than the thickest point and the thinnest point became 3.6 mm by the molding.

In the example 9, the process for applying the surface roughness was performed on only the first member 2 of the mold 4. Specifically, the process was performed so that the spatial frequency of extreme value of PSD in the spatial frequency 6000 [1/mm] to 10,000 [1/mm] on the mold surface at the point in contact with the thickest point of the lens after the molding became 6231 [1/mm], the spatial frequency of extreme value of PSD in the spatial frequency 6000 [1/mm] to 10,000 [1/mm] on the mold surface at the point in contact with the thinnest point of lens became 6845 [1/mm], and the spatial frequency of extreme value of PSD in the spatial frequency 6000 [1/mm] to 10,000 [1/mm] on the mold surface at the point in contact with the freely selected point of lens were 6980 [1/mm].

The molding was performed by the same method as in the example 1 using this mold 4. In the example 9, a few cracks were observed, but the molding was performed at a level that did not cause any problem in terms of specifications. In addition, when the spatial frequency of extreme value of PSD in the spatial frequency 6000 [1/mm] to 10,000 [1/mm] on the surface of the molded lens was measured at the thickest and thinnest points, it was confirmed that the spatial frequency of extreme value of PSD at the thinnest point was higher than the spatial frequency of extreme value of PSD at the thickest point, and it was also confirmed that there was no light quantity distribution.

### Example 10

In the example 10, a glass lens having a concave shape on one-side and a convex shape on one-side near the center was molded. A pair of molds 4 were prepared so that the thickness of the thickest point of the lens became 2.3 mm, the thickness of the thinnest point became 1.4 mm, and the thickness of a point freely selected from the positions other than the thickest point and the thinnest point became 1.7 mm by the molding.

In the example 10, the process for applying the surface roughness was performed only the second member 3 of the mold 4. Specifically, the process was performed so that the spatial frequency of extreme value of PSD in the spatial frequency 6000 [1/mm] to 10,000 [1/mm] on the mold surface at the point in contact with the thickest point of the lens after the molding became 8995 [1/mm], the spatial frequency of extreme value of PSD in the spatial frequency 6000 [1/mm] to 10,000 [1/mm] on the mold surface at the point in contact with the thinnest point of the lens became 9175 [1/mm], and the spatial frequency of extreme value of PSD in the spatial frequency 6000 [1/mm] to 10,000 [1/mm] on the mold surface at the point in contact with the freely selected point of the lens became 8357 [1/mm].

The molding was performed by the same method as in the example 1 using this mold 4. Also in the example 10, a few cracks were confirmed, but the molding was performed at a level that did not cause a problem in terms of specifications. In addition, when the spatial frequency of extreme value of PSD in the spatial frequency 6000 [1/mm] to 10,000 [1/mm] on the surface of the molded lens was measured at the thickest point and the thinnest point, it was confirmed that the spatial frequency of extreme value of PSD at the thinnest point was higher than the spatial frequency of extreme value of PSD at the thickest point, and it was also confirmed that the light intensity distribution was small.

### Comparative Example 6

In the comparative example 6, the molding of a glass lens having the same shape as in the example 6 was performed. In the comparative example 6, the process for applying the surface roughness was performed on both the first member 2 and the second member 3 of the mold 4. Specifically, the process was performed so that the spatial frequency of extreme value of PSD in the spatial frequency 6000 [1/mm] to 10,000 [1/mm] on the mold surface at the point in contact with the thickest point of the lens after the molding became 9910 [1/mm], the spatial frequency of extreme value of PSD in the spatial frequency 6000 [1/mm] to 10,000 [1/mm] on the mold surface at the point in contact with the thinnest point of the lens became 7500 [1/mm], and the spatial frequency of extreme value of PSD in the spatial frequency 6000 [1/mm] to 10,000 [1/mm] on the mold surface at the point in contact with the freely selected point of the lens became 6854 [1/mm].

The molding was performed by the same method as in the example 1 using this mold 4. Also in the comparative example 6, a few cracks were confirmed, but the molding was performed at a level that did not cause any problem in terms of specifications. In addition, when the spatial frequency of extreme value of PSD in the spatial frequency 6000 [1/mm] to 10,000 [1/mm] of the surface of the molded lens was measured at the thickest point and the thinnest point, it was confirmed that the spatial frequency of extreme value of PSD at the thinnest point was higher than the spatial frequency of extreme value of PSD at the thickest point, but the light intensity distribution was large, which caused a problem in terms of specifications.

### Comparative Example 7

In the comparative example 7, the molding of a glass lens having the same shape as in the example 7 was performed. In the comparative example 7, the process for applying the surface roughness was performed on both the first member 2 and the second member 3 of the mold 4. Specifically, the process was performed so that the spatial frequency of extreme value of PSD in the spatial frequency 6000 [1/mm] to 10,000 [1/mm] on the mold surface in contact with the thickest point of the lens after the molding became 7423 [1/mm], the spatial frequency of extreme value of PSD in the spatial frequency 6000 [1/mm] to 10,000 [1/mm] on the mold surface in contact with the thinnest point of the lens became 6156 [1/mm], and the spatial frequency of extreme value of PSD in the spatial frequency 6000 [1/mm] to 10,000 [1/mm] on the mold surface in contact with the freely selected point of the lens became 6985 [1/mm].

The molding was performed by the same method as in the example 1 using this mold 4. In the comparative example 7, finally when the temperature of the mold 4 was lower than the second temperature (580° C.), the applied load was unloaded, but cracking occurred and the molding could not be completed. Since the molding could not be completed, the light intensity distribution could not be measured.

### Comparative Example 8

In the comparative example 8, the molding of a glass lens having the same shape as in the Example 8 was performed. In the comparative example 8, the process for applying the surface roughness was performed on only the first member 2 of the mold 4. Specifically, the process was performed so that the spatial frequency of extreme value of PSD in the spatial frequency 6000 [1/mm] to 10,000 [1/mm] on the mold surface in contact with the thickest point of the lens after the molding became 6465 [1/mm], the spatial frequency of extreme value of PSD in the spatial frequency 6000 [1/mm] to 10,000 [1/mm] on the mold surface in contact with the thinnest point of the lens became 6065 [1/mm], and the spatial frequency of extreme value of PSD in the spatial frequency 6000 [1/mm] to 10,000 [1/mm] on the mold surface in contact with the freely selected point of the lens became 6254 [1/mm].

The molding was performed by the same method as in the example 1 using this mold 4. In the comparative example 8, finally when the temperature of the mold 4 became lower than the second temperature (580° C.), the applied load was unloaded, but cracking occurred and the molding could not be completed. Since the molding could not be completed, the light quantity distribution could not be measured.

### Comparative Example 9

In the comparative example 9, the molding of a glass lens having the same shape as in the Example 9 was performed. In the comparative example 9, the process for applying the surface roughness was performed on only the first member 2 of the mold 4. Specifically, the process was performed so that the spatial frequency of extreme value of PSD in the spatial frequency 6000 [1/mm] to 10,000 [1/mm] on the mold surface in contact with the thickest point of the lens after the molding became 8465 [1/mm], the spatial frequency of extreme value of PSD in the spatial frequency 6000 [1/mm] to 10,000 [1/mm] on the mold surface in contact with the thinnest point of the lens became 7454 [1/mm], and the spatial frequency of extreme value of PSD in the spatial frequency 6000 [1/mm] to 10,000 [1/mm] on the mold surface in contact with the freely selected point of the lens became 8045 [1/mm].

The molding was performed by the same method as in the example 1 using this mold 4. In the comparative example 9, finally when the temperature of the mold 4 was lower than the second temperature (580° C.), the applied load was unloaded, but cracking occurred and the molding could not be completed. Since the molding could not be completed, the light quantity distribution could not be measured.

### Comparative Example 10

In the comparative example 10, the molding of a glass lens having the same shape as in the example 10 was performed. In the comparative example 10, the process for applying the surface roughness was performed on only the second member 3 of the mold 4. Specifically, the process was performed so that the spatial frequency of extreme value of PSD in the spatial frequency 6000 [1/mm] to 10,000 [1/mm] on the mold surface in contact with the thickest point of the lens after the molding became 6946 [1/mm], the spatial frequency of extreme value of PSD in the spatial frequency 6000 [1/mm] to 10,000 [1/mm] on the mold surface in contact with the thinnest point of the lens became 6656 [1/mm], and the spatial frequency of extreme value of PSD in the spatial frequency 6000 [1/mm] to 10,000 [1/mm] on the mold surface in contact with the freely selected point of the lens became 6257 [1/mm].

The molding was performed by the same method as in the example 1 using this mold 4. In the comparative example 10, finally when the temperature of the mold 4 was lower than the second temperature (580° C.), the applied load was unloaded, but cracking occurred and the molding could not be completed. Since the molding could not be completed, the light quantity distribution could not be measured.

The following Table 2 shows the shape of the glass lens, the surface roughness measurement result of the mold 4, the light quantity distribution of the lens, and the result of cracking during molding (degree of cracking) in the examples 6 to 10 and the comparative examples 6 to 10. As the evaluation criterion of the light quantity distribution of the lens, C is defined as a case where the light quantity distribution cannot be confirmed, B is defined as a case where the light quantity distribution can be confirmed to some extent but there is no problem in terms of specifications, and A is defined as a case where the light quantity distribution with a problem in terms of specifications can be confirmed. In addition, as the evaluation criterion of cracks at the time of molding, C is defined as a case in which no cracks can be confirmed, B is defined as a case in which some cracks can be confirmed but there is no problem in terms of specifications, and A is defined as a case in which cracks can be confirmed at a level that there is a problem in terms of specifications.

TABLE 2

| | | | | | | Spatial frequency [1/mm] of extreme | | | | |
|---|---|---|---|---|---|---|---|---|---|---|
| | | | | | | point of PSD (Power Spectral Density) | | | | |
| | | | | | | in spatial frequency from 6000[1/mm] | | | | |
| | | | | | | to 10000[1/mm] of surface of mold | | | | |
| | | Surface(s) | Thickness | Thickness | Thickness | Point in | Point in | Point in | Light | Degree |
| | Shape near | to which | of thickest | of thinnest | of freely | contact with | contact with | contact with | quantity | of |
| | the center | roughness | point of | point of | selected | thickest | thinnest | freely | distri- | crack- |
| | of lens | is applied | lens [mm] | lens [mm] | point [mm] | point of lens | point of lens | selected point | bution | ing |
| Example 6 | Concave on | First member and | 3.5 | 1.2 | 2 | 7584 | 9505 | 8546 | C | C |
| | both-sides | Second member | | | | | | | | |
| Example 7 | Concave on | First member and | 1 | 0.6 | 0.7 | 7986 | 8765 | 8454 | B | C |
| | one-side | Second member | | | | | | | | |
| | Convex on | | | | | | | | | |
| | one-side | | | | | | | | | |
| Example 8 | Convex on | First member | 4.6 | 0.5 | 3 | 6954 | 7561 | 7254 | C | C |
| | both-sides | | | | | | | | | |
| Example 9 | Concave on | First member | 5.3 | 2.1 | 3.6 | 6231 | 6845 | 6980 | C | B |
| | one-side | | | | | | | | | |
| | Convex on | | | | | | | | | |
| | one-side | | | | | | | | | |
| Example 10 | Concave on | Second member | 2.3 | 1.4 | 1.7 | 8995 | 9175 | 8357 | B | B |
| | one-side | | | | | | | | | |
| | Convex on | | | | | | | | | |
| | one-side | | | | | | | | | |
| Comparative | Concave on | First member and | 3.5 | 1.2 | 2 | 9910 | 7500 | 6854 | A | B |
| Example 6 | both-sides | Second member | | | | | | | | |
| Comparative | Concave on | First member and | 1 | 0.6 | 0.7 | 7423 | 6156 | 6985 | — | A |
| Example 7 | one-side | Second member | | | | | | | | |
| | Convex on | | | | | | | | | |
| | one-side | | | | | | | | | |
| Comparative | Convex on | First member | 4.6 | 0.5 | 3 | 6465 | 6065 | 6254 | — | A |
| Example 8 | both-sides | | | | | | | | | |
| Comparative | Concave on | First member | 5.3 | 2.1 | 3.6 | 8465 | 7454 | 8045 | — | A |
| Example 9 | one-side | | | | | | | | | |
| | Convex on | | | | | | | | | |
| | one-side | | | | | | | | | |
| Comparative | Concave on | Second member | 2.3 | 1.4 | 1.7 | 6946 | 6656 | 6257 | — | A |
| Example 10 | one-side | | | | | | | | | |
| | Convex on | | | | | | | | | |
| | one-side | | | | | | | | | |

In the examples 6 to 10, as shown in Table 2, the light quantity distribution could be suppressed. Therefore, it was found that the light quantity distribution expansion could be suppressed in a configuration in which at least one surface of the lens 1 has, at a portion where the thickness of the lens 1 after the molding is relatively thin, the surface roughness larger than the surface roughness of the other portion other.

Further, in the examples 6 to 10, as shown in Table 2, the occurrence of cracks could be suppressed. Therefore, it was found that the occurrence of cracks could be suppressed in a configuration in which at least one of the first member 2 and the second member 3 has, at a portion corresponding to a portion where the thickness of the lens 1 after the molding is relatively thin, the surface roughness larger than the surface roughness of the other portion other.

In addition, in the examples 6 to 8, the occurrence of cracks could be further suppressed. For this reason, it was found that the occurrence of cracks could be further suppressed in a configuration in which at least one of the first member 2 and the second member 3 has, at a portion corresponding to the third portion which is thicker than the first portion and thinner than the second portion of the lens 1 after the molding, the surface roughness smaller than the surface roughness of the portion corresponding to the first portion and larger than the surface roughness of the portion corresponding to the second portion.

### Embodiment 2

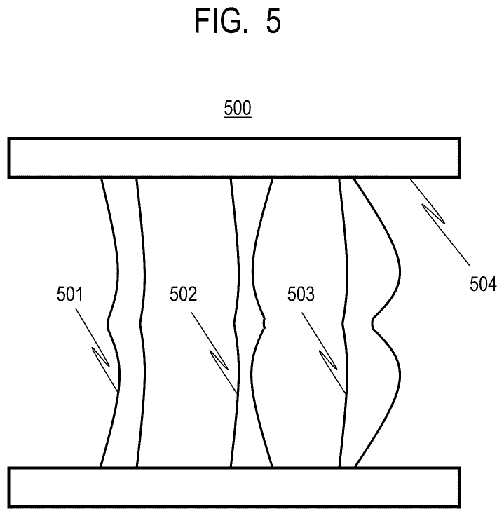

Next, a lens unit according to an embodiment 2 of the present disclosure will be described with reference to FIG. 5. FIG. 5 shows an example of a lens unit according to the embodiment 1. The lens unit 500 according to the embodiment 2 includes a plurality of lenses 501, 502, 503 and a lens-barrel 504. The lens-barrel 504 holds a plurality of lenses 501, 502, 503. Here, the plurality of lenses 501, 502, 503 are configured by using the lenses described in the embodiment 1.

According to such a configuration, since the lens unit is constituted by using a glass lens which has a small light quantity distribution and is prevented from cracking during the molding, the lens unit using a high-accuracy glass lens can be stably produced.

The lens unit may include at least one lens described in the embodiment 1, and the plurality of lenses included in the lens unit may include another lens. The number of the plurality of lenses is not limited to three, and two or more lenses may be included in the lens unit.

### Embodiment 3

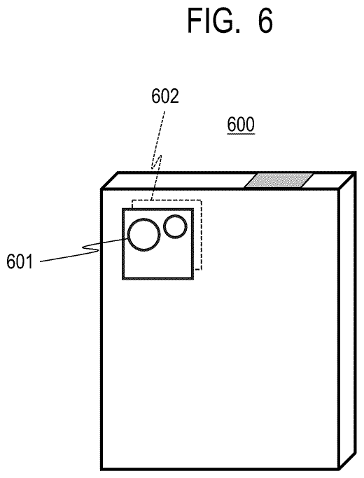

Next, an information terminal according to the embodiment 3 of the present disclosure will be described with reference to FIG. 6. FIG. 6 shows an example of the information terminal according to the present embodiment. The information terminal according to the embodiment 3 may be any known information terminal such as a mobile phone, a smartphone, a laptop PC (Personal Computer), or a tablet terminal. The information terminal 600 according to the present embodiment includes a lens 601 and an image sensor 602. The lens 601 is configured by using the lens described in the embodiment 1. The image sensor 602 can perform imaging via the lens 601.

According to such a configuration, since the information terminal is configured by using a lens which has a small light quantity distribution and is prevented from cracking during molding, the information terminal which uses a high-accuracy lens and has good imaging performance can be stably produced. Note that the information terminal 600 may include two or more of the lenses described in the embodiment 1. Further, the information terminal 600 may include the lens unit described in the embodiment 2.

### Embodiment 4

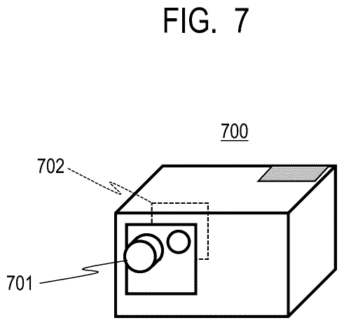

Next, an imaging apparatus according to an embodiment 4 of the present disclosure will be described with reference to FIG. 7. FIG. 7 shows an example of the imaging apparatus according to the embodiment 4. The imaging apparatus according to the embodiment 4 may be any known imaging apparatus such as a digital camera or an analog camera. The imaging apparatus 700 according to the embodiment 4 includes a lens 701 and an image sensor 702. The lens 701 is configured using the lens described in the embodiment 1. The image sensor 702 can perform imaging via the lens 701.

According to such a configuration, since the image sensor is configured using a lens which has a small light quantity distribution and is prevented from cracking during the molding, the imaging apparatus which uses a high-accuracy lens and has a good imaging performance can be stably produced. The imaging apparatus may include two or more of the lenses described in the embodiment 1. The image sensor 700 may include the lens unit described in the embodiment 2.

The lens according to the present disclosure is described as a glass lens in the embodiments 1 to 4. However, the material of the lens is not limited to glass. The lens according to the present disclosure may be molded of, for example, plastic or any resin. The plastic lens may be injection-molded using a mold.

According to the first aspect of the present disclosure, the optical characteristics of the aspherical lens can be improved. In addition, according to the second aspect of the present disclosure, the occurrence of cracks during the molding of the aspherical lens can be suppressed.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-217351, filed Dec. 12, 2024, and Japanese Patent Application No. 2025-179472, filed Oct. 24, 2025, which are hereby incorporated by reference herein in their entirety.

What is claimed is:

1. A lens comprising a first optically effective surface and a second optically effective surface which intersect an optical axis, wherein:
at least one of the first optically effective surface and the second optically effective surface has an inflection point between an intersection with the optical axis and an effective region end;
a distribution of thickness between the first optically effective surface and the second optically effective surface in a direction parallel to the optical axis has an extreme value at a position away from the optical axis in a direction perpendicular to the optical axis;
the at least one of the first optically effective surface and the second optically effective surface has, at a first portion of the lens, surface roughness larger than surface roughness of a second portion of which a thickness is thicker than the first portion; and
a difference between the surface roughness of the first portion and the surface roughness of the second portion is 1.0 nmRa or more in arithmetic average roughness.

2. The lens according to claim 1, wherein the difference between the surface roughness of the first portion and the surface roughness of the second portion is 10 nmRa or less in the arithmetic average roughness.

3. The lens according to claim 1, wherein the at least one of the first optically effective surface and the second optically effective surface of the lens has, at a third portion of which a thickness is thicker than the first portion and thinner than the second portion, surface roughness smaller than the surface roughness of the first portion and larger than the surface roughness of the second portion.

4. The lens according to claim 1, wherein the at least one of the first optically effective surface and the second optically effective surface of the lens has, at a point of which the thickness is minimum among a point group including a point corresponding to the intersection with the optical axis, a point corresponding to the effective region end of the lens, and a point having the extreme value in the distribution of thickness of the lens, surface roughness larger than the surface roughness of a point of which the thickness is maximum among the point group.

5. The lens according to claim 4, wherein the at least one of the first optically effective surface and the second optically effective surface of the lens has, at a point away from the point of which the thickness is maximum and the point of which the thickness is minimum among the point group, surface roughness smaller than the surface roughness of the point of which the thickness is minimum and larger than the surface roughness of the point of which the thickness is maximum.

6. The lens according to claim 1, wherein surface roughness of the at least one of the first optically effective surface and the second optically effective surface of the lens changes stepwise or continuously.

7. The lens according to claim 1, wherein surface roughness of the at least one of the first optically effective surface and the second optically effective surface of the lens is applied in accordance with a thickness of the lens.

8. The lens according to claim 7, wherein the at least one of the first optically effective surface and the second optically effective surface of the lens has surface roughness such that the thinner a thickness of a portion of the lens, the larger surface roughness of the portion of the lens.

9. The lens according to claim 1, wherein the at least one of the first optically effective surface and the second optically effective surface of the lens has surface roughness applied by at least one of laser processing, polishing processing, ion beam processing, and blasting.

10. The lens according to claim 1, wherein the surface roughness of the first portion and the second portion of the at least one of the first optically effective surface and the second optically effective surface of the lens is between 2 nmRa and 12 nmRa in the arithmetic average roughness.

11. The lens according to claim 1, wherein the surface roughness of the first portion and the second portion of the at least one of the first optically effective surface and the second optically effective surface of the lens has a spatial frequency of an extreme value of power spectral density of the first portion higher than a spatial frequency of an extreme value of power spectral density of the second portion, in a spatial frequency 6000 [1/mm] to 10,000 [1/mm] expressed in a power spectral density.

12. The lens according to claim 1, wherein a difference between the maximum thickness and the minimum thickness of the lens is between 0.4 mm to 5.0 mm.

13. A mold comprising:
a pair of a first member and a second member used for press-molding a lens having a first optically effective surface and a second optically effective surface intersecting an optical axis, wherein at least one of the first optically effective surface and the second optically effective surface has an inflection point between an intersection with the optical axis and an effective region end, and wherein a distribution of thickness between the first optically effective surface and the second optically effective surface in a direction parallel to the optical axis has an extreme value at a position away from the optical axis in a direction perpendicular to the optical axis,
wherein at least one of the first member and the second member has, at a first correspondence portion corresponding to a first portion of the lens, surface roughness larger than surface roughness of a second correspondence portion corresponding to a second portion of the lens of which a thickness is thicker than the first portion.

14. The mold according to claim 13, wherein a difference between the surface roughness of the first correspondence portion and the surface roughness of the second correspondence portion is 1.0 nmRa or more and 10 nmRa or less in arithmetic average roughness.

15. The mold according to claim 13, wherein the surface roughness of the first correspondence portion and the second correspondence portion is between 2 nmRa and 12 nmRa in arithmetic average roughness.

16. The mold according to claim 13, wherein the surface roughness of the first correspondence portion and the second correspondence portion of the at least one of the first member and the second member has a spatial frequency of an extreme value of power spectral density of the first portion higher than a spatial frequency of an extreme value of power spectral density of the second portion, in a spatial frequency 6000 [1/mm] to 10,000 [1/mm] expressed in a power spectral density.

17. A lens unit comprising:
the lens according to claim 1; and
a lens-barrel holding a plurality of lenses including the lens.

18. An information terminal comprising:
the lens according to claim 1; and
an image sensor configured to perform imaging via the lens.

19. An imaging apparatus comprising:
the lens according to claim 1; and
an image sensor configured to perform imaging via the lens.

20. A molding method for press-molding a lens having a first optically effective surface and a second optically effective surface intersecting an optical axis, the molding method comprising:
press-molding the lens using a mold, wherein at least one of the first optically effective surface and the second optically effective surface has an inflection point between an intersection with the optical axis and an effective region end, wherein a distribution of thickness between the first optically effective surface and the second optically effective surface in a direction parallel to the optical axis has an extreme value at a position away from the optical axis in a direction perpendicular to the optical axis, and wherein the at least one of the first optically effective surface and the second optically effective surface has, at a first portion of the lens, surface roughness larger than surface roughness of a second portion of which a thickness is thicker than the first portion,
wherein a difference between the surface roughness of the first portion and the surface roughness of the second portion is 1.0 nmRa or more in arithmetic average roughness.
